(19) United States
(12) Patent Application Publication
(10) Pub. No.: US 2006/0017324 A1
(43) Pub. Date: Jan. 26, 2006

(54) Communications network using installed electrical power lines

(75) Inventors: Timothy Gerald Pace, St. Peters, MO (US); Ray Glendon Buckles, Holloister, MO (US); Bonnie Ruth Hatton, Follett, TX (US)

Correspondence Address: Max Shaftal;Patzik, Frank Samotny Ltd., Suite 900, 150 S. Wacker Drive, Chicago, IL, 60606, US

(73) Assignee: Advanced Powerline Technologies, Inc.

(21) Appl. No.: 11/186,048

(22) Filed: Jul. 21, 2005

Related U.S. Application Data
(60) Provisional application No. 60/589,766, filed on Jul. 21, 2004.

(51) Int. Cl. H02J 3/02; G05B 11/01

(52) U.S. Cl. 307/3; 340/310.11

(57) ABSTRACT

The present invention relates to a system for networking electrical devices to provide interactive communication therebetween utilizing the existing power distribution network installed in a building or structure. Each device utilizes employs an RF transmitter/receiver, a power line coupler and circuitry to regulate the 120v, 60 Hz power being distributed through the network. The RF transmitter/receiver at each device convert the information signal generated in the device, to a signal which is supplied to the power coupler. The power coupler introduces the RF signal to the power distribution network. A display device containing a like power coupler and RF transmitter/receiver receives the signal from the distribution network. The display device converts the signal back to a signal format used to display the information. The physical location of the display device can be anywhere within the building since the signal has been transmitted over the installed power distribution network.

### PRIORITY CLAIM

This application claims priority to U.S. Provisional Patent Application Ser. No. 60/589,766 filed on Jul. 21, 2004.

### FIELD OF THE INVENTION

This invention relates to a communications network using the installed electrical power lines in a building or other structure to control apparatus powered therefrom.

### BACKGROUND OF THE INVENTION

There are a wide variety of devices that either transmit data to or receive data from other devices. Computers send display data to monitors and print data to printers. Television sets accept video data from Video Cassette Recorders and Digital Video Disc Players. Networks broadcast programming via radio waves while cable providers transmit programming to their customers via coaxial cable. When data needs to be transmitted, designers must first choose between direct wired and wireless communication. While a number of devices do communicate wirelessly, many designers choose a direct wired connection to avoid range, security, and/or performance problems with wireless communication. A number of different wire types have been developed to transfer this data. Modern televisions sets often come with many jacks to connect one or more coaxial cables, composite video cables, component video cables, and S-video cables. Many stereo systems have what is often described as a “rat's nest” of cables behind them linking the various components, while computer users must deal with monitor cables, serial cables, parallel cables, USB cables, and Fire-Wire cables. This multiplicity of cables and cable types make it difficult and sometimes intimidating for users of average ability to install these systems or reconfigure them.

Most of the devices that transmit data to or receive data from other devices are powered by being plugged into an electrical outlet. In the United States, this means a 120V, 60 Hz AC power line. While most homes in the US do not have telephone, coaxial, and computer network connections in every room, there are usually multiple power outlets in every room. Others have taken advantage of the prevalence of electrical outlets to couple data to the existing power lines for transmission between devices. Some of these systems are commercially available and usually involve pairs of enclosures, each containing a power line coupler/decoupler, such that the sending device is cabled to one enclosure, which couples the data to the power line, and another enclosure decouples the data from the power line and sends it via cables to the receiving device. The data is coupled to the power line by encoding it at a frequency sufficiently higher than the 60 Hz of the power line that it does not interfere with the line's ability to transmit power.

While this does allow the power lines to transmit the data, it has two significant limitations. First, there is no method to allow multiple devices of different types to all send data, potentially of vastly different types, on the same power line. Second, these devices do not eliminate the multiple wires and wire types needed to connect devices because each device must be connected to an enclosure that couples/decouples the data from to/from the power line.

The existing installation of power distribution lines throughout the buildings or other structures is a potential wiring system heretofore unsuccessfully used on a wide scale for the transmission of information signals. The distribution lines serving as the source of power to computers, appliances, entertainment equipment provide an opportunity for closed loop monitoring and control of the different interconnected equipment. To date, this capability has not been utilized to a major extent due in part to the increasing interest in wireless technology. Wireless technology has limitations based on the portion of the frequency spectrum available for use, and it is doubtful that the entire inventory of electrical apparatus in a typical household could be effectively controlled by wireless equipment.

The present invention is directed to a system for networking electrical devices to provide interactive communication therebetween utilizing the existing power distribution network installed in the building or structure. Each device utilizing the system employs an RF transmitter/receiver, the power line coupler and circuitry to regulate the 120v, 60 Hz power being distributed through the network.

The RF transmitter/receiver at each device serves to convert the information signal generated in the device, for example, a video camera, to the signal which is supplied to the power coupler. The power coupler introduces the RF signal to the power distribution network in the building. A display device containing a like power coupler and RF transmitter/receiver receives the signal from the distribution network. The display device converts the signal back to a signal format used to display the information, e.g., an LCD video screen. The physical location of the display device can be anywhere within the building since the signal has been transmitted over the installed power distribution network.

The command and control signals for each unit on the system can be sent over the power distribution network or generated from a wireless central command unit which can be carried by the user to the location of the device being activated.

While the system has significant application to home entertainment equipment, the subject invention can be used to control a computer system which includes multiple peripheral components. The network cables coupling the various components, including the display screen of a computer, can be eliminated in favor of the existing power distribution network for transmission of data.

The present invention has further utility by using the networked computer system to control and monitor the operation of household appliances. The appliances each contain a power line coupler for connection to the existing power distribution network and an RF transmitter/receiver for processing the RF signals. The command and controls signals can be transmitted as RF signals through the network or wireless control can be utilized.

This present invention overcomes the first limitations by using the power line as a single, high speed, all-digital, serial network, into which every piece of equipment is linked by a compatible power line network coupler. This allows the transmission from different types of devices of vastly different types of data to coexist on the same power line in the same way that computers can now connect to printers, scanners, cameras and other widely varied devices using the same network cable.

This present invention overcomes the second limitation by incorporating a Power Line Coupler into the devices that send and receive data, so that no external connections other than the power cords are necessary. A security camera can be plugged into one electrical outlet, the monitor can be plugged into another outlet, and the video data from the camera can be displayed on the monitor with no connections except the power cords. A television could select between video data from a commercial programming feed, multiple VCRs, multiple DVD players, and multiple security cameras, all with no connection other than a power cord. Instead of trying to find the right cables and connectors to install a computer with a monitor, printer, and scanner, a user could simply plug all the items into power outlets and be connected. This greatly simplifies the task of installing or reconfiguring systems because no cable changes are necessary.

This invention has obvious applications for audio/visual entertainment equipment, computer equipment, security equipment, environmental control systems, and telephones and other audio/visual communications equipment. It can also be applied to public area cameras such as traffic or surveillance cameras, port or airport security cameras, and early warning weather cameras, as well as military surveillance of areas of possible hostile activity. In addition, any appliance that connects to the power line can have a network coupler included so that it can allow itself to be controlled remotely, send status or error data, and send warrantee data via the power lines. Even rechargeable devices that are not always connected to the power line can send data via the power line while they are connected to the power line for recharging.

This invention overcomes limitations in current power line data transmission systems and greatly expands the potential for power line communication for devices for which such communication had never seriously been considered, making it a significant addition to the state of the art in power line communication.

Further features and advantages of the invention will become more readily apparent from the following description of specific embodiments when taken in conjunction with the accompanying drawings.

### SUMMARY OF THE INVENTION

The present invention relates to a method of facilitating communication between an AC-powered electrical component and a second device over an AC power network. The method comprises the steps of:
providing an AC power network comprising AC power lines configured to carry AC power signals, the network configured to operatively interconnect the first AC powered component and second device;
generating a first signal at the first AC powered component;
integrally forming a transmitter and receiver system into the first AC powered component, forming a radio frequency transmitter into the first AC powered component, the radio frequency transmitter configured to receive the first signal and convert the first signal into a first radio frequency signal;
coupling the radio frequency signal onto an AC power signal and transmitting the first radio frequency signal from the first AC powered component to the second component over an AC power line;
decoupling the radio frequency signal from the AC power line and receiving the radio frequency at the second component; and
converting the radio frequency signal into a second signal at the second component.

The method further comprises the step of providing an isolation system for selectively allowing radio frequency signals coupled to the AC power signal to pass through to the transmitter and receiver system. A third signal is generated at the second component, the third signal is converted into a second radio frequency signal, is coupled onto an AC power signal and transmitted from the second component to the first AC powered component over the AC power line. The second radio frequency signal is decoupled from the AC power signal and is received by the first component where it is converted into a fourth signal.

The present invention also comprises a system for facilitating communication between an AC-powered electrical component and a second device over an AC power network, the system comprising an AC power network comprising AC power lines configured to carry AC power signals, and the AC power network configured to operatively interconnect the first AC powered component and second device; a first signal generated by the first AC-powered component; a transmitter and receiver system integrally formed into the first AC-powered component generating a first signal at the first AC powered component, the transmitter and receiver system configured to receive the first signal and convert the first signal into a first radio frequency signal; a power line coupler operatively associated with the first AC-powered component and configured to couple the first radio frequency signal onto an AC power signal and to facilitate transmission of the first radio frequency signal from the first AC powered component to the second component over the AC power line; and a receiver operatively associated with the second component and configured to receive the first radio frequency signal and convert the first radio frequency signal into a second signal. An isolation system for selectively allowing radio frequency signals coupled to the AC power signal to pass through to the transmitter and receiver system.

### BRIEF DESCRIPTION OF THE FIGURES

FIG. 1 shows a schematic diagram of a transmitter and receiver system of the preferred embodiment of the present invention;

FIG. 2 shows a schematic diagram of a power line coupler in accordance with the present invention;

FIG. 3 shows a schematic diagram of a second power line coupler in accordance with the present invention;

FIG. 4 shows a schematic diagram of a first preferred application of the present invention;

FIG. 5 shows a schematic diagram of a first preferred application of the present invention;

FIG. 6 shows a schematic diagram of a first preferred application of the present invention;

FIG. 7 shows a schematic diagram of a first preferred application of the present invention;

FIG. 8 shows a schematic diagram of a first preferred application of the present invention;

FIG. 9 shows a schematic diagram of a component of the present inventive system;

FIG. 10 shows a schematic diagram of a first preferred application of the present invention; and

FIG. 11 shows a schematic diagram of a first preferred application of the present invention.

### DETAILED DESCRIPTION OF THE FIGURES

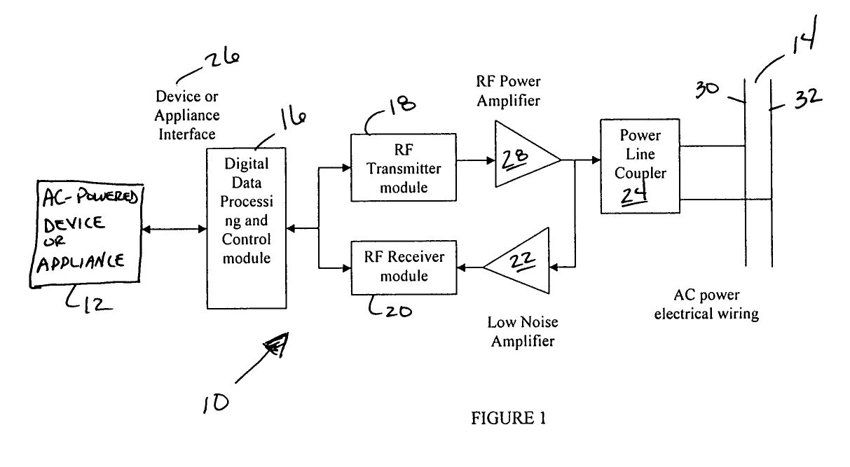

FIGS. 1-11 of show a number of applications of the present inventive data communications system. FIG. 1 shows a Transmitter and Receiver System 10 to be incorporated into an AC-powered component to enable communication between the component 12 and another device over an AC power grid 14. The primary function of the Transmitter and Receiver System 10 is to convert digital data or analog signals to be transmitted into acceptable RF signals to be injected onto the AC power electrical wiring 14 and to convert RF signals received on the AC power electrical wiring 14 back into its original digital data or analog signals. The digital data or analog signals are used to perform some type of action or interface to the device or appliance 12 the Transmitter and Receiver System 10 is integrated into. The Transmitter and Receiver System 10 functions can be accomplished using various standard methods and techniques but will describe in a preferred embodiment herein.

The generic Transmitter and Receiver System 10 of the present invention consists of Digital Data Processing and Control module 16, RF Transmitter module 18, RF Receiver module 20, Low Noise Amplifier 22, and Power Line Coupler 24. The Digital Data Processing and Control module 16 provides an interface 26 between the Appliance or Device 12 to be controlled or communicated with and the RF Transmitter module 18 and RF Receiver module 20. Additionally, Digital Data Processing and Control module 16 provides control signals for RF Transmitter module 18, RF Receiver module 20, RF Power Amplifier 28, and Low Noise Amplifier 22. Digitized data from Digital Data Processing and Control module 16 is fed into RF Transmitter module 18 where it is converted using standard RF modulation techniques into an RF signal to be injected onto the AC power electrical wiring 30, 32 and AC power grip 14, RF Transmitter module 18 feeds the RF signal into RF Power Amplifier 28 to boost the RF output power to acceptable levels for signal transmission. The output of RF Power Amplifier 28 connects to the RF signal input/output of Power Line Coupler 24. Power Line Coupler 24 acts as an impedance matching antenna that closely matches the characteristic impedance of the AC power electrical wiring 30, 32 allowing the RF signal to effectively couple to AC power grid 14. The input of Low Noise Amplifier 22 connects to the input/output of Power Line Coupler 24 allowing any RF signal on the AC power grid 14 picked up by the Power Line Coupler 24 to be fed into the input of Low Noise Amplifier 22 to amplify the RF signal to acceptable levels. The output of Low Noise Amplifier 22 is connected to the input of RF Receiver module 20 allowing the amplified RF signal to be fed into RF Receiver module (C). RF Receiver module (C) converts the RF signal into its original digital data using standard RF demodulation techniques. The output of RF Receiver module 20 is connected to Digital Data Processing and Control module 16. RF Receiver module 20 feeds the original digital data into Digital Data Processing and Control module 16. The Digital Data Processing and Control module 16 interfaces with and/or performs some action on the Appliance or Device 12 to be controlled or communicated with or the Transmitter and Receiver System itself 10.

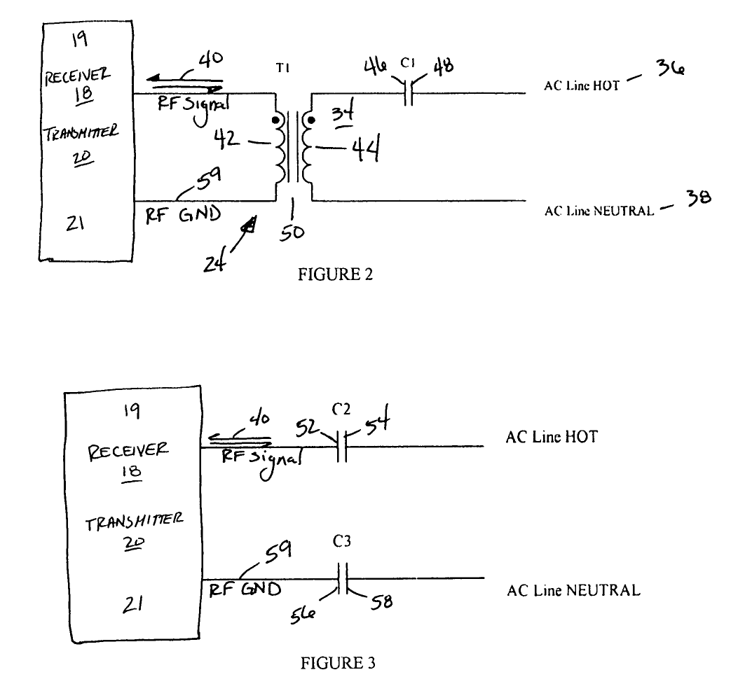

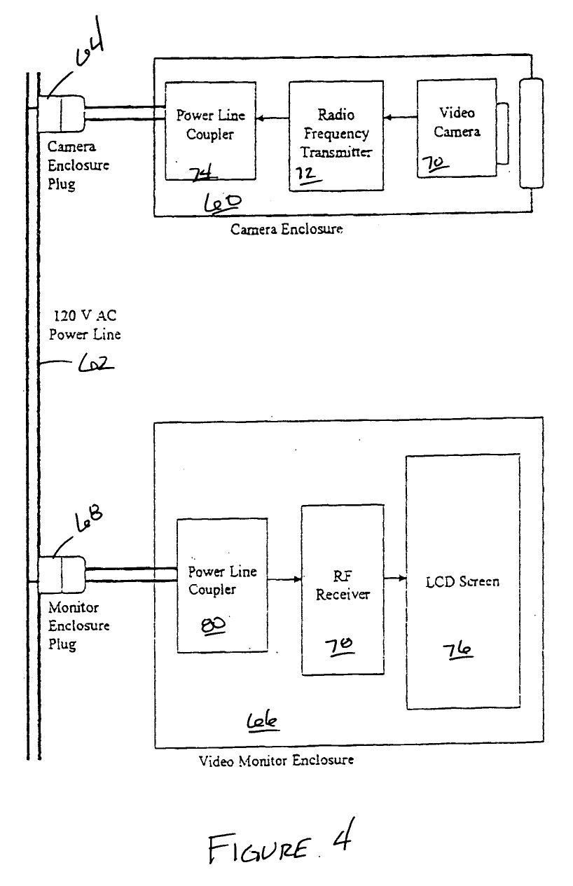

FIGS. 2 and 3 show a first and second embodiment of the Power Line Coupler 24 of FIG. 1 in greater detail. In FIG. 2, the Power Line Coupler 24 consists of an RF Transformer and Capacitor network 34 whose component values and configuration is in such a manner to closely match the characteristic impedance of the AC Power electrical wiring 36, 38. The configuration of the coupler network blocks low frequency AC signals, such as the 50/60 Hz AC power itself, and passes high frequency RF signals, such as those generated by an RF signal transmitter.

In transmission mode, the RF signal output 40 from the RF Transmitter Module 18 is connected to the primary side 42 of RF transformer (T1). The first end 46 of capacitor (C1) is connected to one end of the secondary winding 44 on RF transformer (T1). The second end 48 of capacitor (C1) is connected to the Line or “HOT” side 36 of the AC power electrical wiring. The remaining end 50 of RF transformer (T1) is connected to the “NEUTRAL” side 38 of the AC power electrical wiring. The RF signal output 40 from the RF Transmitter Module 18 is injected onto the primary side 42 of the RF transformer (T1). The RF transformer (T1) couples the RF signal 40 from the primary winding 42 to the secondary winding 44 of RF transformer (T1) while effectively isolating the RF Transmitter Module 18 output circuitry from the high voltage AC power on the electrical wiring 36, 38. Capacitor (C1) provides low frequency current blocking to prevent the AC power on the electrical wiring 36, 38 from freely flowing through the secondary winding 42 of RF transformer (T1). Additionally, capacitor (C1) provides low frequency signal blocking, such as the 50/60 Hz AC power signal, while passing higher frequency RF signals, such as the RF signal from the RF Transmitter Module 18. The capacitance value of capacitor (C1) and the inductance values of the primary and secondary windings 42, 44 of RF transformer (T1) are carefully chosen to closely match the characteristic impedance of the AC Power electrical wiring 36, 38 and the output impedance of the RF Transmitter Module 18 circuit.

In receiver mode, the RF signal input 40 to the RF Receiver Module 20 is connected to the primary side 42 of RF transformer (T1). The first end 46 of capacitor (C1) is connected to one end of the secondary winding 44 on RF transformer (T1). The second end 44 of capacitor (C1) is connected to the Line or “HOT” side 36 of the AC power electrical wiring. The remaining end 50 of RF transformer (T1) is connected to the “NEUTRAL” side 38 of the AC power electrical wiring. The RF signal 40 carried on the AC power electrical wiring passes through capacitor (C1) and is injected onto the secondary winding 44 of RF transformer (T1). Capacitor (C1) provides low frequency signal blocking, such as the 50/60 Hz AC power signal, while passing higher frequency RF signals, such as the RF signal from a transmitter. The RF transformer (T1) couples the RF signal 40 from the secondary winding 44 to the primary winding 42 of RF transformer (T1) while effectively isolating the RF receiver input circuitry from the high voltage AC power on the electrical wiring 36, 38. Capacitor (C1) provides low frequency voltage blocking to prevent the AC power on the electrical wiring 36, 38 from freely flowing through the secondary winding 44 of RF transformer (T1). The capacitance value of capacitor (C1) and the inductance values of the primary and secondary windings 42, 44 of RF transformer (T1) are carefully chosen to closely match the characteristic impedance of the AC Power electrical wiring 36, 38 and the input impedance of the RF Receiver Module circuit.

Referring to FIG. 3, in transmission mode, the RF signal output 40 from the high side 19 of the RF Transmitter Module 18 is connected to one end 52 of capacitor (C2) and the other end 54 of capacitor (C2) is connected to the Line or “HOT” side 36 of the AC power electrical wiring. The low side 21 of the RF Transmitter Module 18 is connected to one end 56 of capacitor (C3) and the other end 58 of capacitor (C3) is connected to the “NEUTRAL” side 38 of the AC power electrical wiring. Capacitor (C2) and capacitor (C3) effectively couple the RF signal 40 from the RF Transmitter Module 18 while effectively isolating the RF Transmitter Module 18 output circuitry from the high voltage AC power on the electrical wiring 36, 38. Capacitor (C2) and capacitor (C3) provide low frequency current blocking to prevent the AC power on the electrical wiring 36, 38 from freely flowing into the RF Transmitter Module 18 circuit. Additionally, capacitor (C2) and capacitor (C3) provide low frequency signal blocking, such as the 50/60 Hz AC power signal, while passing higher frequency RF signals, such as the RF signal 40 from the RF Transmitter Module 18. The capacitance values of capacitor (C2) and capacitor (C3) are carefully chosen to closely match the characteristic impedance of the AC Power electrical wiring and the output impedance of the RF Transmitter Module 18 circuit.

In receiver mode, the RF signal input high side 19 of the RF Receiver Module 20 is connected to one end 52 of capacitor (C2) and the other end 54 of capacitor (C2) is connected to the Line or “HOT” side 36 of the AC power electrical wiring. The low side 21 of the RF Receiver Module 20 is connected to one end 56 of capacitor (C3) and the other end 58 of capacitor (C3) is connected to the “NEUTRAL” side 38 of the AC power electrical wiring. The RF signal carried on the AC power electrical wiring passes through capacitor (C2) and is injected into the RF input high side 19 of the RF Receiver Module 20. Capacitor (C3) provides a return path, or RF GND 59, for the RF signal input of the RF Receiver Module 20. Capacitor (C2) and capacitor (C3) effectively couple the RF signal to the RF receiver while effectively isolating the RF receiver input circuitry from the high voltage AC power on the electrical wiring. Capacitor (C2) and capacitor (C3) provide low frequency current blocking to prevent the AC power on the electrical wiring from freely flowing into the RF signal receiver circuit. Additionally, capacitor (C2) and capacitor (C3) provide low frequency signal blocking, such as the 50/60 Hz AC power signal, while passing higher frequency RF signals, such as the RF signal carried on the AC power electrical wiring 36, 38. The capacitance values of capacitor (C2) and capacitor (C3) are carefully chosen to closely match the characteristic impedance of the AC Power electrical wiring and the input impedance of the RF receiver circuit.

While the Power Line Couplers 24 shown in FIGS. 2 and 3 describe the preferred embodiments of the AC power line coupling system, it is recognized that other methods of coupling an RF signal to the AC power lines exists. Any other embodiment of the AC power line coupling system may be used provided it sufficiently matches the impedance of the AC power electrical wiring to provide efficient coupling of the RF signal, and provided it sufficiently blocks low frequency signals while passing high frequency RF signals.

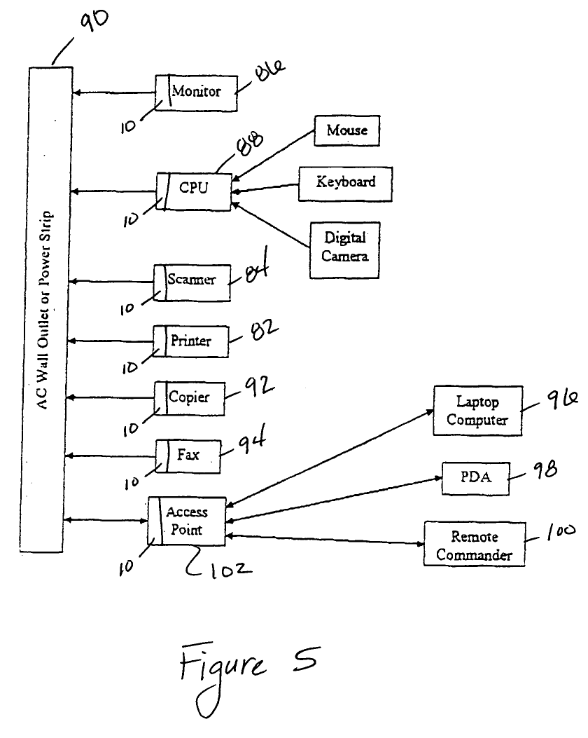

Turning now to FIG. 4, a first application of the present invention consists of a camera enclosure 60 that connects to the 120 VAC power line 62 through the camera enclosure plug 64, and a video monitor enclosure 66 that connects to the 120 VAC power line 62 through the video monitor enclosure plug 68 Neither the camera enclosure 60 nor the video monitor enclosure 66 requires other external connections, either wired or wireless, so that the user is not required to make any connections other than the power connection, and the enclosures can be used anywhere that the 120 VAC power line 62 is available, although adding optional connectors to either enclosure, either wired or wireless, would still fall within the scope of this invention.

The camera enclosure 60 consists of a video camera 70 with a composite video output, with the camera lens mounted to view through an opening or transparent section of the enclosure, a radio frequency transmitter 72, a Power Line Coupler 74, and circuitry to regulate the 120V, 60 Hz AC power for use by other components of the enclosure (not shown).

The video monitor enclosure 66 consists of an LCD video screen 76 with a composite video output, a radio frequency transmitter 78, a power line coupler 80, and circuitry to regulate the 120V, 60 Hz AC power for use by other components of the enclosure.

When the camera enclosure 60 is plugged into the power line 62, the video camera 70 captures the video stream within view of its lens and transfers that video stream, via its composite video output, to the radio frequency transmitter 72. The radio frequency transmitter 72 converts the video signal to a radio frequency signal. Instead of radiating the signal through an antenna, the RF transmitter 72 transfers the signal to the power line coupler 74. The Power Line Coupler 74 couples the radio frequency signal onto the 120 VAC power line 62 for transmission via the power line.

The Power Line Coupler 80 in the video monitor enclosure 66 decouples the radio frequency signal from the 120 VAC power line 62 and feeds it into the radio frequency receiver 78. The radio frequency receiver 78 converts the signal back to composite video and transfers the composite video signal into the LCD video screen 76. The LCD video screen 76 displays the video, thereby allowing the user to view the video stream captured by the camera from anywhere that he can access the 120 VAC power line 62.

The addition of optional additional connections to either enclosure, whether wired or wireless, the use of a digital video camera, the use of component video, digital video, or other type of video signals instead of composite video, and the use of a CRT, plasma, or other type of display screen would still fall within the scope of this invention.

By utilizing the present inventive concept, any piece of home entertainment equipment, e.g. stereos, VCR's, DVD players, and televisions, can be connected together through the home AC electrical wiring. Each unit can simply be plugged into the AC outlet that supplies its power. Data communication or command and control signals for each unit can be sent over this same power connection, thereby eliminating the need for the data and coaxial cables and wires that currently are utilized to couple these components together.

For example, the cable TV signal could come into the house through the power lines, and every TV in the house can pick up the signal, no matter where it is in the home because all that is needed is to plus it into the power outlet. No cable wiring is needed anywhere in the home, just the AC power outlets that are already there. The same is true for the video and audio signals from a DVD player or VCR. By plugging these components into the AC outlet enables them to send and receive video and audio signals through the house AC power wiring, without the need for additional cables and wires. Audio signals from a stereo or home theater system can be sent throughout the home to other components in the system in a similar manner. Simply plug the stereo and other units into the AC power outlet, and all audio and control signals can be sent and received over the house power lines to any other unit in the system. Again, no other cables or hookups needed. Even the stereo speakers or home intercom speakers can simply be connected to the AC power outlet and receive the audio and data signals. The speakers would need to have their own audio power amplifier built into them for this configuration, but some stereo system speakers already have this feature, and all intercom systems already have this feature. This simply eliminates the need to run separate audio wires throughout the house. In addition, video can be added to a home intercom system.

When multiple components are connected to the network, each device identifies itself when it is added to the network (i.e. when it is plugged in), and that identification includes the type of device and data, and may optionally include a unique address with which it can be identified. Each device contains a unique address which it supplies when it identifies itself. A different address may be assigned to devices by the power line network hub for use by the local power line network. In the preferred embodiment, the power line network hub would assign addresses, but the address supplied by the devices themselves would be available to support installations that did not include a power line network hub.

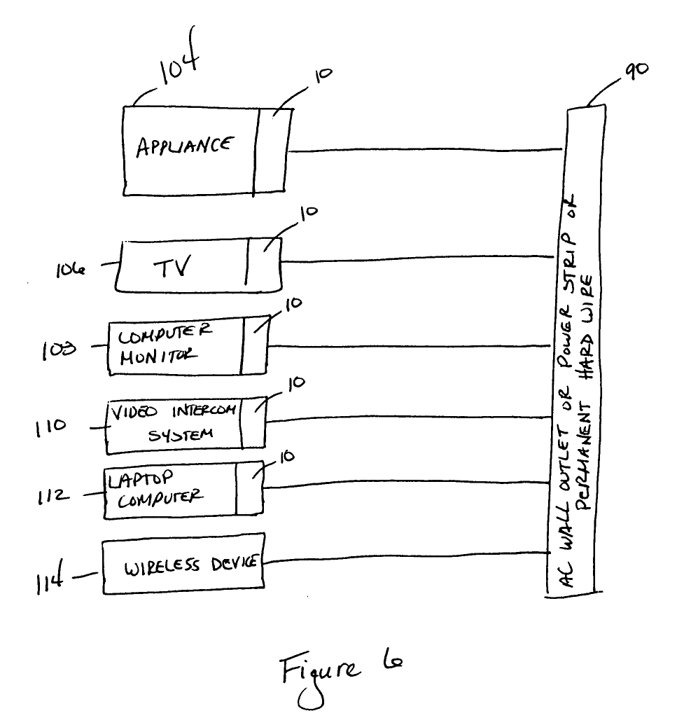

In a second application to the present invention, shown in FIG. 5, the invention enables computer systems to connect all the different peripheral components, such as printers 82, scanners 84, monitors, CPU's 88, speakers (not shown), routers, and the like, through the distribution network. Each of these peripheral components has the Transmitter and Receiver System 10 of the present invention. There would be no need to have a cable from a printer 82 to the CPU 88, or from the monitor 26 to the CPU 88, or from the scanner 84 to the CPU 88. All these devices would simply plug into the AC wall outlet 40 just like they do now, for power, but this would now also serve as the data connection between them, thereby eliminating the otherwise necessary bundles of cables used to connect each peripheral device to the CPU.

In addition, networking multiple computers together can be accomplished through the AC power wiring in the home, office building, manufacturing facility, retail building, or any other facility. This would eliminate the need to run expensive network cables throughout the building to network all the computers. It would also eliminate the problems with RF wireless networks, problems such as interference, drop out, reliability and security issues.

Using the Transmitter and Receiver System described herein, the modem and internet connection would also be provided through the AC wall outlet power connection. Telephone service can be run throughout the house on the AC power lines, allowing the computer to act as an answering machine or fax machine, all through this one AC power connection.

There may still be some things that would be more convenient to plug into the CPU, such as the keyboard or mouse, or a digital camera that plugs into the USB or other port on the front of the CPU to download its pictures.

For example:
a) Simply plug the power cord for the monitor into the AC wall outlet, plug the power cord for the CPU into the wall outlet, plug the keyboard and the mouse into the CPU, to complete the computer system.
b) Add a printer or scanner to the computer system by simply plugging their power cords into the AC wall outlet, and these components are instantly part of the computer system without the need for additional cables.
c) This instantly creates an entire computer network for multiple computers to be networked together. There is no need to run Ethernet cables throughout the home, office building, manufacturing facility, retail building or any other facility to have computers networked together. They are automatically that are networked together simply because they are plugged into the AC outlet for power without the need for a separate router. The network cards built into the computers will serve that purpose.
d) Peripherals such as printers 82, scanners 84, copiers 92, faxes 94 and the like. can be located anywhere in the building, yet be shared by all computers in the building. This is possible because all of them plug into the AC wall outlet 90 for power, connecting all of them to the network through this one connection.
e) This network also allows for mobile computing such as laptops 96, PDA's 98 or the “Remote Command” unit 100. RF wireless access points 102 containing a Transmitter and Receive System can be placed anywhere in the home, office building, manufacturing facility, retail building, or any other facility. Simply plugging the device into an AC wall outlet for power connects it to the network through the one power connection. This allows for as many access points as needed, so that there are no dead spots in the building for the mobile units. This means that mobile units can easily surf the internet, fax documents, make telephone calls (even video phone calls), send and receive email or text messaging, act as a mobile intercom or walkie-talkie for household members, employees or other personnel to stay in contact with each other, and command every function of the entire house (smart home application), office building, manufacturing facility, retail building, or any other facility. Complete control is provided and information can be transferred from every device in the facility to everything on the internet and on your person at all times, if desired.

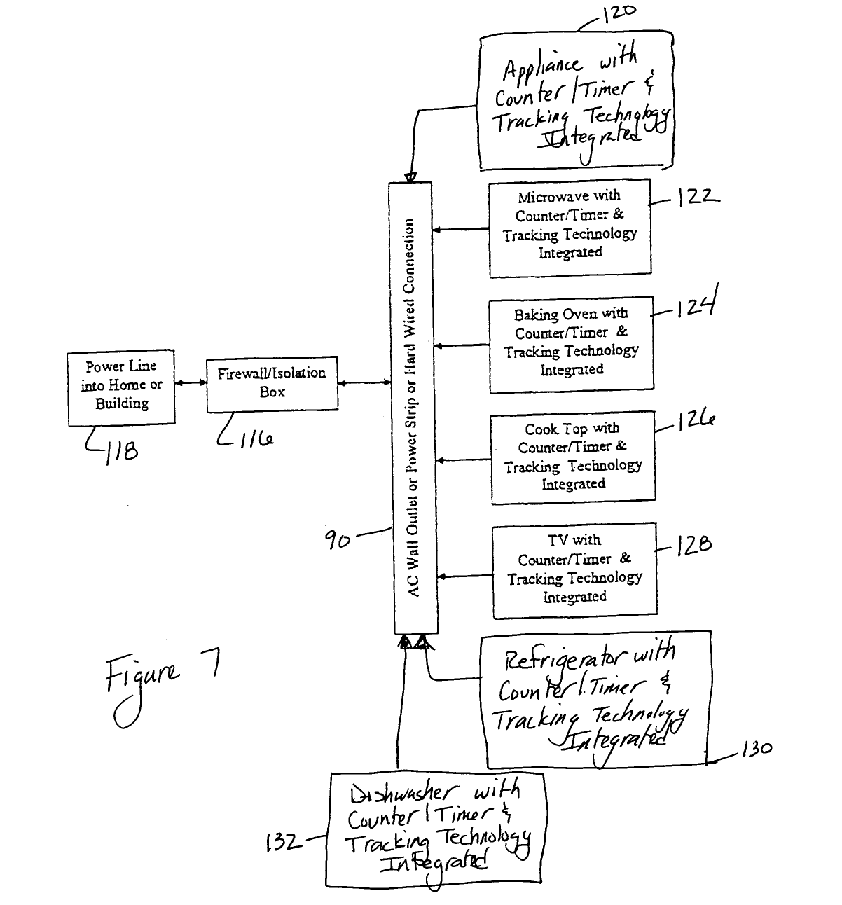

FIGS. 6 and 7 show additional applications of the present invention. Among these applications is the control of appliances 104 as seen in FIG. 6, such as refrigerators, freezers, microwave ovens, cook tops, baking ovens, cooking ranges, trash compactors, dishwashers, coolers, food processors, blenders, toasters, mixers, bread makers, clothes washers, clothes dryers, clothes irons, etc., that can all be automatically networked into the home automation system when they are plugged into the AC power outlet or permanently hardwired to the AC power 90, such as with cooking ranges, dishwashers and trash compactors. This can save energy and make household tasks easier and more convenient. For example, dishwashers can be loaded throughout the day and programmed to run during the night when electricity demand is low. If the user forgets to put dishwashing soap in, the dishwasher can alert you of this on any TV 106, computer monitor 108, video intercom system 110, laptop 112, or a wireless device 114 “Remote Command”, cell phone, PDA, or any other mobile or fixed device. The dishwasher can wait until you add soap before it runs. The user can also check the status of the dishwasher from any computing device in the house to find out the point where it is at in the wash cycle.

Additionally, the wireless command device 114 could have a bar code or RFID scanner built into it. It also could be used to scan groceries or other items into and out of the household inventory database—items such as clothes, stationery supplies, music CD's, DVD's, VHS tapes, games, literally anything with a bar code or RFID tag.

With such a database, shopping lists could be generated for groceries, clothing, etc., on demand. This will streamline the tasks of homemakers trying to keep up with today's busy lifestyles. These shopping lists could either be printed on paper to take with you, or stored on a PDA or “Remote Command” that you have with you. In addition, the user can access a home inventory database remotely while out shopping, in case the user sees something he/she may need but is not sure whether he/she already has the item, or if the user finds a sale on an item and wants to know how many he/she has in a home inventory. This capability creates a smart consumer able to manage time, household and financial resources wisely.

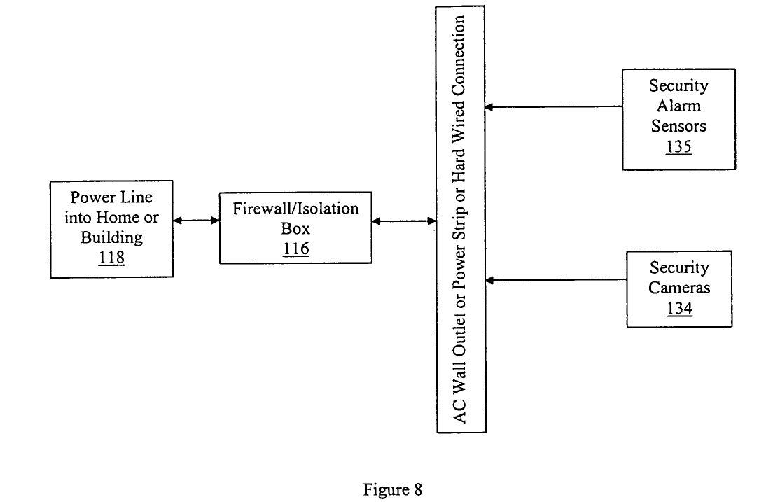

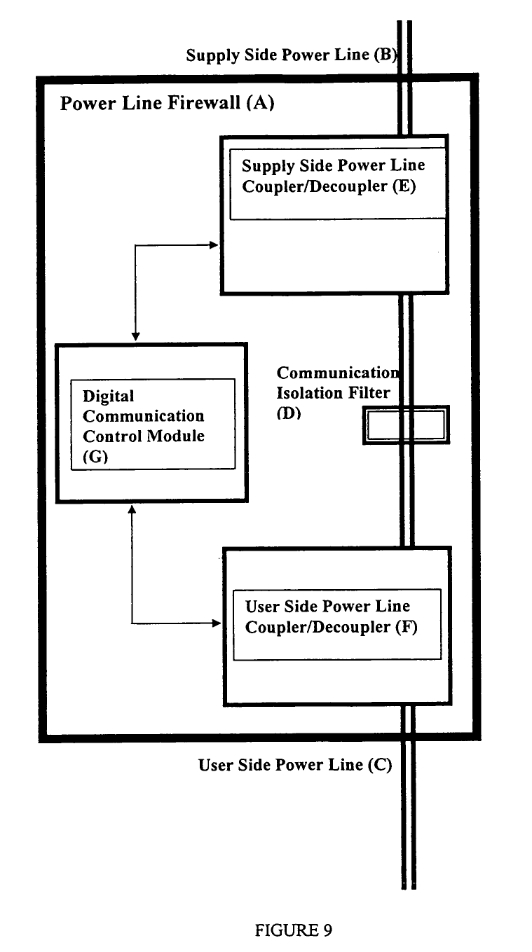

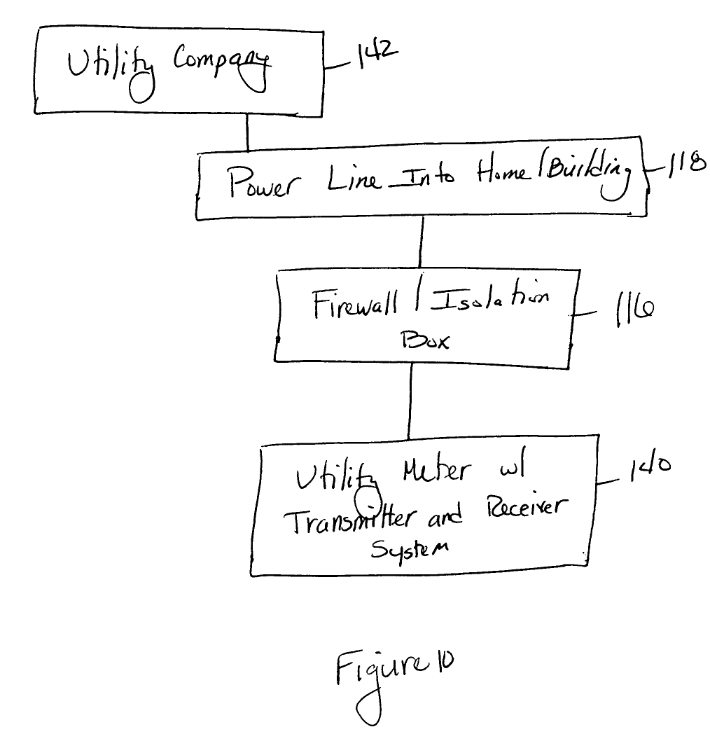

In order for the network at each house, office building, manufacturing facility, retail building or other facility to be isolated from the network in another building, and to prevent hackers from breaking into the network, there needs to be a firewall and network isolation box 116 (FIGS. 7 and 8) installed at each building. FIG. 9 shows the Power Line Firewall in greater detail.

This Power Line Firewall 116 will contain both hardware and software firewall technology to prevent hackers or any other unauthorized individuals or entities from breaking into the network in the building it protects. Since all the homes, office buildings, manufacturing facilities, retail buildings or any other facility are connected to the power grid 118, this box will also serve as a means to isolate each facility's network from other networks. This prevents someone from giving the command to turn on their dishwasher and causing all the dishwashers in the neighborhood to turn on.

In addition, the Power Line Firewall 116 can prioritize, sort or filter data or commands coming into the home, office building, manufacturing facility, retail building or other facility from remote locations. This allows a person be at work or in the car and use either the internet or cell phone or wireless PDA to remotely command functions or access data or inventory at the person's home, office building, manufacturing facility, retail building, or any other facility to which it is connected. This would include video data from security cameras located throughout the house, office building, manufacturing facility, retail building or other facility and on the grounds. If a parent has kids at home alone, or an elderly family member that a person wants to keep tabs on while the child is gone from the home, the parent or child can do so using the present invention and the proper authorization codes from the home or building network.

In addition, using the present invention, updates can be downloaded to this Power Line Firewall 116 over the power lines 118. Updates can include software for firewall protection, access codes, network protocol upgrades, and others.

Although the address of the home, office building, manufacturing facility, retail building or other facility where the Power Line Firewall box 116 is installed can be recorded by the installer and entered into a database, it may also incorporate GPS (Global Positioning System) technology into each Power Line Firewall box 116. This could be used to create an exact GPS grid coordinate map to overlay the address map of every installed box enabling the tracking of removal or relocation of a box 116.

Specifically, the function of the Power Line Firewall device is to isolate the section of the power protected by the firewall with regard to communication, while still allowing electrical power to pass freely through it. It prevents unauthorized data from outside the firewall from being transmitted to the power line inside it, and it prevents internal data not authorized for release outside the firewall from being transmitted to the power line outside it.

The supply side of the Power Line Firewall (A) is connected to the supply side power line (B) and the user side is connected to the user side power line (C). The communication isolation filter (D) isolates communication on the user side of the Power Line Firewall (A) from the supply side and isolate communication on the supply side from the user side. In the preferred embodiment, the communication isolation filter (D) takes the form of a low pass filter which filters out all communication frequencies while being transparent to the 60 Hz AC power frequency.

The digital communication control module (G) monitors communication on the supply side of the Power Line Firewall (A) by means of the supply side power line coupler/decoupler (E), which decouples data from the supply side power line (B) and provides it to the digital communication control module (G) as digital data. If the digital communication control module (G) detects data that is addressed to a device inside the firewall and is authorized by the user for transmission, it sends the data to the user side power line coupler/decoupler (F), which couples data onto the user side power line (C) for transmission to its intended target. Any data not properly address and authorized is discarded by the digital communication control module (G).

The digital communication control module (G) monitors communication on the user side of the Power Line Firewall (A) by means of the user side power line coupler/decoupler (F), which decouples data from the supply side power line (C) and provides it to the digital communication control module (G) as digital data. If the digital communication control module (G) detects data that is addressed to a device outside the firewall and is authorized by the user for transmission, it sends the data to the supply side power line coupler/decoupler (E), which couples data onto the supply side power line (B) for transmission to its intended target. The digital communication control module (G) also monitors communication on the user side of the Power Line Firewall (A) for communication directed to it to establish what communication is authorized to pass through the firewall. Any data not properly address and authorized is discarded by the digital communication control module (G).

In the preferred embodiment, the digital communication control module (G) is composed of a microprocessor with either integrated or external flash memory, RAM, and data ports. The microprocessor is programmed to perform the above described functions. The program and information identifying communication that has been authorized to pass through the firewall is stored in the flash memory. Data monitored from the supply side power line (B) and the user side power line is stored in RAM until it is either transmitted or discarded.

Another feature of the present invention, as shown in FIG. 7, is the incorporation of counter/timer and tracking technology. With counter/timer and tracking technology added to the Transmitter and Receive System technology, it is possible to track and store usage time and other data for every device in the home connected to the AC power. This means anything that plugs into the AC wall outlet for power can have counter/timer technology incorporated into it, and this data can be stored and tracked. Anytime a device is plugged in, such as a microwave oven 120, baking oven 122, cook top 124, television 126, hair dryer, power drill, electric shaver, sewing machine, food processor or blender, the counter/timer technology stores new data in the device and updates the Firewall/Isolation box 116 with the information. If a device is permanently connected to the AC power, such as a refrigerator 130, microwave oven 122, dishwasher 132, cook top 126, or baking oven 124 etc., the data could still be stored in our Firewall/Isolation box 118, or it could be stored in the device and accessed by our Firewall/Isolation box 118, as needed, for retrieval.

Access to this data would be filtered, sorted and stored by the Firewall/Isolation box 118 described above. Using the present invention, an entity wanting to use this data might be required to pay a fee for access to the Firewall/Isolation box 116 to retrieve this data at their convenience, with proper authorization. Additionally, they might pay a fee to be granted direct access to devices that are permanently connected to the AC power 90, such as a refrigerator 130, microwave oven 122, dishwasher 132, cook top 126, baking oven 124, etc. The access code could restrict them to only access certain data on certain devices and for a certain length of time. This access code could also restrict them to a certain numbers of homes, which could be regional or random across the community, state or nation.

As seen in FIG. 8, the subject invention permits video cameras 134, with or without audio microphones for sound, to be placed anywhere in the house, office building, manufacturing facility, retail building or other facility, or on the grounds, and simply plugged into an AC outlet for power. This automatically connects any number of devices to the network. The cameras can be on continuously or triggered to turn on by motion detectors or some other sensing device. Using this technology, the devices could also be commanded to turn on remotely with proper authorization, using the Internet 136 or any other fixed or mobile device 138, such as a cell phone, PDA, laptop, or “Remote Command”.

Further, a security company can, with proper authorization, receive the video and/or audio signal from the cameras in the home, office building, manufacturing facility, retail building or other facility. In this way, they can more quickly and accurately assess the situation. This will help avoid false alarms and help reduce the cost of home, office building, manufacturing facility, retail building other facility security. In addition, recorded video and audio can be used as evidence in court to help convict the criminal. It can also become a record of what property was stolen or damaged. This security monitoring can also be triggered and authorized by the security alarm being tripped. The home owner or facility manager can be alerted to a break-in or breach of security at the same time as the security company by using a cell phone, PDA, “Remote Command” or other mobile device.

In addition, video cameras and sensors can be installed on power poles throughout the country, particularly in an area known for severe weather, such as “Tornado Alley” in the United States. The cameras can be constructed and mounted so that they can rotate and pan to look at different views and different angles around their location. When a tornado approaches or comes through, the sensors can detect and cause the cameras to move into a viewing position. Also, the cameras can be remotely controlled from FEMA or The National Weather Service to view the tornado. Using the present invention, the sensors can be collecting data on the tornado and transmitting the data over the power lines. They may even be able to get some data, including video data, from directly inside the tornado as it passes over a power pole before the pole and sensors are destroyed by it.

Since this would create a sensor and video grid, early warning of a tornado or other severe weather for the citizens in its path becomes very practical and inexpensive to implement. The sensors or cameras can have GPS technology installed in them, giving the exact GPS coordinates for every location. The tornado cannot only be tracked by video and its intensity measured by sensors, but there can also be an exact calculation and plot of its path from the time it forms until it dissipates.

The present invention can also be used to monitor hurricanes, and to assess the damage caused by them. This will help in both early warning and rescue efforts. It will also help disaster relief efforts to be more efficient and responsive. Agencies and volunteers can prioritize efforts by knowing in advance the level of destruction for different areas, and the location of potential victims in need of immediate help.

Today, municipalities are installing video cameras at traffic intersections or at the construction zones. They are used for many purposes, including monitoring the volume of traffic, ticketing and prosecuting people who run the stop lights, and monitoring high crime areas. The current video systems are expensive to install because either the RF wireless system must be used to transmit the video signal, or cables must be run all over the city to carry the video signal.

RF wireless systems are not secure. The signal can be tapped into by anyone with the proper equipment. There can also be gaps in reception using an RF wireless system. These gaps can be caused by weather conditions, outside electrical interference, and much more, causing the entire system to be unreliable. Hard cabled systems are more secure and more reliable, but are very expensive to install. The cable must be run on power lines or buried underground all over the city to get the video signal. This is a monumental effort and can have ongoing maintenance or rental fees to hang the cable on the power poles.

The present invention permits a video camera to be installed anywhere there is a power source. The connection to the AC power lines also provides the method to transmit the video data to any location desired. No additional cabling needs to be installed and maintained, no security or dead zone issues exist, unlike RF wireless, and the system can be installed at a fraction of the cost of either RF wireless or hard cabled systems.

Also, video cameras and other sensors can easily and inexpensively be installed at seaports, airports, buildings and other outdoor areas around the country. Video and sensor data can be sent to a central location for monitoring and review by Homeland Security or other governmental officials using a secure transmission technology. The secure transmission can be accomplished by combining the technology for spread spectrum transmission with the present invention.

By using this technology, telephone service can be routed throughout the home, office building, manufacturing facility, retail building or other facility, on the AC lines. There would be no need for phone jacks or telephone cabling in the home, office building, manufacturing facility, retail building, or other facility. A telephone or fax machine could simply be plugged into any AC power outlet in the home, office building, manufacturing facility, retail building or other facility, and be instantly connected to the telephone service. As a result, the power utility companies could now compete with telephone service providers such as Southwestern Bell to provide local or long distance telephone service to its customers. Alternatively, the power utility company can offer its power lines to existing telephone service providers anywhere in the country, thereby allowing the customers to choose service providers.

In another use of the invention, power utility companies can offer digital cable TV service and internet or broadcast radio service to their customers. The digital cable TV service and internet or broadcast radio service can come into a home, office building, manufacturing facility, retail building or any other facility over the AC power lines. The cable companies will no longer have a monopoly on cable service in a given area. Also, radio stations can connect directly into the utility power lines to transmit their programs to home, office buildings, manufacturing facilities, retail buildings, or any other facility in their licensed region. Alternatively, the power company can purchase or obtain radio programs from radio stations anywhere in the world and provide those stations to their customers using the present invention. Electric, gas and water utility companies have been testing different ways to automate or remotely read their usage meters. They are constantly trying to implement ways to reduce the manpower needed to read the meters while still getting accurate and reliable readings. Some methods use an RF wireless transceiver or transmitter integrated into the meter. This allows a meter reader to drive by the facility and collect the meter reading using a mobile device to receive the transmitted reading from the meter. Alternatively, the reading can be transmitted to a repeater unit installed to receive the transmission from within range, typically several meters.

As shown in FIG. 10, using the present invention, the utility meters incorporating the Transmitter and Receive System of the present invention 140 can be read over the power lines 118 that already exist in the facility provided the proper access codes enable the utility company 142 to get past the Firewall/Installation Box 116. This could dramatically reduce the cost to utility companies to read their meters, and it could easily be implemented by virtually all utility companies, with minimal expense.

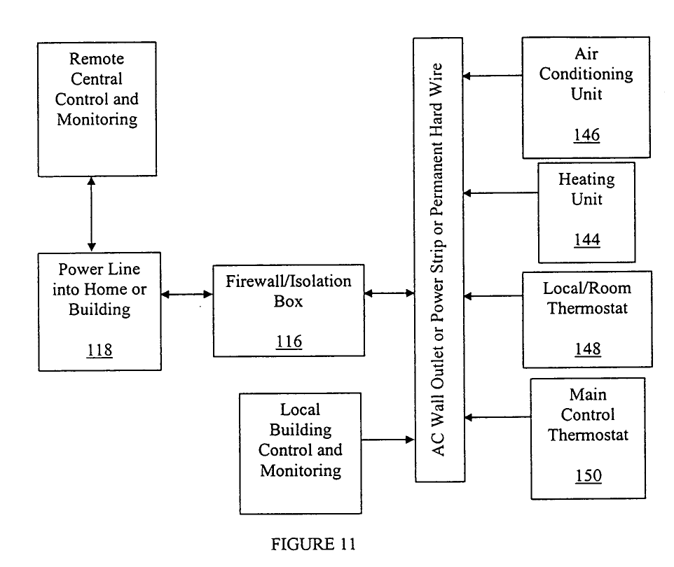

As is shown in FIG. 11, the present invention also enables heating 144, ventilation and air conditioning 146 systems to be controlled throughout the home, office building, manufacturing facility, retail building or any other facility. Multiple systems inside large homes, office buildings, manufacturing facilities, retail buildings and other facilities can all be linked together over the power lines in each of the buildings. Thermostats 148, 150 and other climate control and monitoring devices, such as a computer, can also be connected to the AC power lines to control the systems.

HVAC systems installed in large facilities are expensive to install. In order to control the climate, temperature or humidity in a large facility, thermostats or other temperature or humidity monitoring devices are placed throughout the facility in various rooms. The monitoring devices send data back to a central control unit, which can be a computer, a master thermostat, or other device. If desired, the monitoring devices can be set for the desired temperature or humidity in the monitored room by the people working or living in that room, while other rooms are set independently. The central control unit uses these settings to control the entire HVAC system in order to maintain the different settings with the most efficient use of energy.

Currently, for this type of HVAC system to work, cable must be run throughout the facility to interconnect all the monitoring devices, the heating and air conditioning units, and the central control device. This is very expensive due to the cost of the cables and the intensive labor needed to run the cables throughout the facility.

Alternatively, monitoring devices, the central control, and the heating and air conditioning units can be connected using RF wireless technology. This type of installation becomes very expensive due to the cost of the transceivers and the effort to install and maintain them. Additionally, many of the monitoring devices are battery powered, which means that the batteries in each device have to periodically be replaced or the system will stop working. If the monitoring devices are powered by the AC power in the building, then you still have to run low voltage AC power cables to every monitoring device, adding to the expense. Also, RF wireless transmissions can be interfered with by many outside devices, causing temporary gaps in the data and the central control unit's ability to control the system properly.

Using the present invention, HVAC control systems can be installed using low voltage AC power with no need to run data cables. This gives the reliability of a hardwired system without the expense of running data cables throughout the building.

While the above description has referred to a number of embodiments, it is recognized that modifications and variations to the invention may be made without departing from the scope thereof.

We claim:

1) A method of facilitating communication between an AC-powered electrical component and a second device over an AC power network, the method comprising the steps of:
providing an AC power network comprising AC power lines configured to carry AC power signals, the network configured to operatively interconnect the first AC powered component and second device;
generating a first signal at the first AC powered component;
integrally forming a transmitter and receiver system into the first AC powered component, forming a radio frequency transmitter into the first AC powered component, the radio frequency transmitter configured to receive the first signal and convert the first signal into a first radio frequency signal;
coupling the radio frequency signal onto an AC power signal and transmitting the first radio frequency signal from the first AC powered component to the second component over an AC power line;
decoupling the radio frequency signal from the AC power signal and receiving the radio frequency at the second component; and
converting the radio frequency signal into a second signal at the second component.

2) The method of claim 1 wherein the first and second signals is a video signal.

3) The method of claim 1 wherein the first and second signals are analog communication signals.

4) The method of claim 1 further comprising providing an isolation system for selectively allowing radio frequency signals coupled to the AC power signal to pass through to the transmitter and receiver system.

5) The method of claim 1 further comprising:
generating a third signal at the second component;
converting the third signal into a second radio frequency signal;
coupling the second radio frequency signal onto an AC power signal and transmitting the second radio frequency signal from the second component to the first component over the AC power line;
decoupling the second radio frequency signal from the AC power line and receiving the radio frequency at the first component; and
converting the second radio frequency signal into a fourth signal at the second component.

6) The method of claim 5 wherein the third and fourth signal is a video signal.

7) The method of claim 5 wherein the third and fourth signal is an analog communication signal.

8) The method of claim 5 further comprising providing an isolation system for selectively allowing radio frequency signals coupled to the AC power signal to pass through to the transmitter and receiver system.

9) The method of claim 1 wherein the second component comprises an AC powered component and the first and second components are both connected to the AC power network through a power cord associated with each of the first and second AC-powered components.

10) The method of claim 1 wherein the first AC-powered component comprises a video camera and the second component comprises a video monitor.

11) The method of claim 1 wherein the first AC-powered component comprises a central processing unit and the second component comprises a computer peripheral.

12) A system for facilitating communication between an AC-powered electrical component and a second device over an AC power network, the system comprising:
an AC power network comprising AC power lines configured to carry AC power signals, and the AC power network configured to operatively interconnect the first AC powered component and second device;
a first signal generated by the first AC-powered component;
a transmitter and receiver system integrally formed into the first AC-powered component generating a first signal at the first AC powered component, the transmitter and receiver system configured to receive the first signal and convert the first signal into a first radio frequency signal; and
a power line coupler operatively associated with the first AC-powered component and configured to couple the first radio frequency signal onto an AC power signal and to facilitate transmission of the first radio frequency signal from the first AC powered component to the second component over the AC power line;
a receiver operatively associated with the second component and configured to receive the first radio frequency signal and convert the first radio frequency signal into a second signal.

13) The system of claim 12 wherein the first and second signals is a video signal.

14) The system of claim 12 wherein the first and second signals are analog communication signals.

15) The system of claim 12 further an isolation system for selectively allowing radio frequency signals coupled to the AC power signal to pass through to the transmitter and receiver system.

16) The system of claim 12 wherein the second component comprises an AC powered component and the first and second components are both connected to the AC power network through a power cord associated with each of the first and second AC-powered components.

17) The system of claim 12 wherein the first AC-powered component comprises a video camera and the second component comprises a video monitor.

18) The system of claim 12 wherein the first AC-powered component comprises a central processing unit and the second component comprises a computer peripheral.
